(19) United States
(12) Patent Application Publication
(10) Pub. No.: US 2007/0043461 A1
(43) Pub. Date: Feb. 22, 2007

(54) Ultra-sound sensor activation

(76) Inventor: Josef Fehrenbach, Haslach (DE)

Correspondence Address: FAY KAPLUN & MARCIN, LLP, 15O BROADWAY, SUITE 702, NEW YORK, NY, 10038, US

(21) Appl. No.: 11/501,965

(22) Filed: Aug. 10, 2006

Related U.S. Application Data
(60) Provisional application No. 60/709,090, filed on Aug. 16, 2005.

(30) Foreign Application Priority Data
Aug. 16, 2005 (DE) 10 2005 038 607.5

(51) Int. Cl. G06F 17/00

(52) U.S. Cl. 700/94

(57) ABSTRACT

Parameterisation, operational checking or data smayning are signifimayt operating steps in process automation. According to an exemplary embodiment of the present invention a field device for process automation is stated, which field device comprises a detector for detecting acoustic signals. Thus parameterisation, operational checking or data smayning in an acoustic way is provided. Data transmission does not necessitate any recesses, drill holes or windows in the housing of the field device.

### RELATED APPLICATIONS

This application claims the benefit of the filing date of the US-Provisional Application 60/709,090 filed on Aug. 16, 2005 and of the German patent application 10 2005 038 607.5 filed on August 16, 2005, the disclosure of which both is hereby incorporated by reference.

### FIELD OF THE INVENTION

The present invention relates to process automation. In particular, the present invention relates to a field device for process automation, to the use of such a field device for fill level measuring, and to a method for operating such a field device.

### TECHNOLOGICAL BACKGROUND

In process automation technology, field devices are used that serve to acquire and/or control process variables.

Such field devices are, for example, fill level meters, manometers, thermometers, flow meters and the like, which by means of their sensors acquire the corresponding process variables, such as fill level, pressure, temperature or flow.

So-called actuators such as valves, heating elements, cooling elements or pumps, by means of which actuators process variables may subsequently be influenced, are further examples of such field devices.

Moreover, the field devices may be designed in the form of input units or output units that control or select the sensors or actuators.

In order to parameterise or smay such field devices, a process control system may be used which, using a cable, is connected to the field device by way of a corresponding interface. Furthermore, an input module may be firmly connected to the field device. For parameterisation or smayning, the field device is then opened, and the input unit is operated manually.

Patent specification DE 103 26 627 A1 relates to a method for displaying the function of a field device relating to process automation technology. In this arrangement a radio signal is transmitted from a transmitting unit to the field device, which triggers a smay of the field device status in the field device. Corresponding to the result of the device smay, a perceptible signal is generated.

### SUMMARY OF THE INVENTION

According to an exemplary embodiment of the present invention a field device for process automation is stated, comprising a detector for detecting a first acoustic signal, and a control unit for carrying out an operating step as a reaction to the detected first acoustic signal, wherein the operating step comprises parameterisation, an operational check or a data smay.

By providing a detector for the detection of acoustic signals the field device may be addressed in a contactless manner. In this arrangement data transmission takes place acoustically, by sound waves that are picked up by the detector. Such sound waves are easy to generate, and propagate even through a housing wall of the field device into the interior of the field device.

Furthermore, the field device may also be operated without any direct visual contact to the field device, such as around corners or through barriers (for example a wall or the like) because the sound waves may also propagate through masonry and around corners.

According to a further exemplary embodiment of the present invention the first acoustic signal comprises parameterisation data for carrying out parameterisation.

In this way, data that is required for the parameterisation of the field device may be transmitted to the field device, as acoustic signals, in a contactless manner from the outside.

According to a further exemplary embodiment of the present invention the field device further comprises a memory for storing measured data. To this purpose the field device may comprise a measuring unit or may be connected to a measuring unit that supplies the data. For example, the measuring unit may be a fill level sensor.

According to a further exemplary embodiment of the present invention the first acoustic signal is an ultrasound signal. By using ultrasound signals, due to the high frequency involved, relative high data density may be transmitted. Furthermore, ultrasound signals are not located in the audible spectrum so that it may not be possible to expose the surroundings to noise.

According to a further exemplary embodiment of the present invention the first acoustic signal may be generated by a handheld transmitter or a stationary computer.

By generating the acoustic signal by means of an electrical device such as a mobile phone, handheld device or a PC, it may be possible to transmit precisely defined signal sequences. For example, specific keys of the handheld transmitter may trigger the transmission of specific signal sequences. In this way simple and interference-free operation may be ensured.

According to a further exemplary embodiment of the present invention the first acoustic signal may be generated by a person.

For example, the person may speak a specific chain of orders so as to trigger an operational check or data smay. It may also be possible for the user (person) to orally carry out parameterisation of the field device. There may thus be no need for an additional handheld transmitter or an external computer for triggering the field device.

According to a further exemplary embodiment of the present invention the detector comprises a sound transducer for transforming the first acoustic signal to an electrical signal.

For example, the detected sound signal may thus be digitised for further processing.

According to a further exemplary embodiment of the present invention the sound transducer comprises a piezoelectric element. This use of a piezoelectric element may provide simple and effective transformation of the acoustic signal to an electrical signal.

For example, the detector may be arranged in the interior of the housing of the field device so that the detector is largely protected from external influences.

In particular, it may be possible to design the housing so that it is pressure-proof so that the electronics arranged in the housing, together with the detector, are protected even in the case of extreme external conditions.

In particular, arranging the detector in the interior of the housing may result in there being no need to provide holes for cable bushings or the like. The sensor may completely be arranged in the interior of the housing, and data transmission between the external handheld transmitter or the external computer or user and the detector may take place in a contactless manner through the wall of the housing. There may be no need to provide any windows, leadthroughs or the like. In this way the stability of the field device, its robustness and durability may be signifimaytly improved.

According to a further exemplary embodiment of the present invention the detector is directly affixed to an interior wall of the housing. For example, the detector may be in the form of a piezoelectric element that is glued onto the interior wall and that thus picks up vibrations or oscillations of the internal wall, which vibrations or oscillations are generated by the sound impinging from the outside, and transforms said vibrations or oscillations to a corresponding electrical signal.

The housing may be made from a shielding material, such as for example a metal or a ferromagnetic material, which may prevent the transmission of radio waves or magnetic signals.

According to a further exemplary embodiment of the present invention the detector is arranged within an electronics unit. For example, the detector and the evaluation electronics or control electronics and regulation electronics may be arranged in a housing within the field device. Furthermore, it may be possible for at least some of the detector to form part of an integrated circuit which is part of the electronics of the field device.

According to a further exemplary embodiment of the present invention the detector comprises a laser for detecting mechanical oscillations, wherein the mechanical oscillations are generated by the first acoustic signal.

By means of such a laser it may be possible to detect minimal oscillation amplitudes. Optical detection of mechanical oscillations (for example of the housing wall) may make possible sensitive detection. For example, the laser light may be directed onto the interior housing surface, from which surface it is subsequently reflected. A photodiode may then, for example, by means of interferometry, measure and subsequently analyse the reflected signal.

According to a further exemplary embodiment of the present invention the field device further comprises a transmitter for transmitting a second acoustic signal, wherein the second acoustic signal comprises smayned data that results from the carried-out smay, or operational check data that results from the carried-out operational check.

In this way bidirectional data exchange between the field device on the one hand and a user or a corresponding device on the other hand may be possible, which data exchange is based on acoustic signals.

According to a further exemplary embodiment of the present invention the detector and the transmitter form an operational unit. The detector and sender may thus be the same device (for example a piezo crystal), which is alternately used for detection and transmission.

According to a further exemplary embodiment of the present invention the use of a field device according to the above exemplary embodiments is stated for fill level measuring. Fill level measuring devices may thus be parameterised, checked or smayned in a contactless manner by way of acoustic signals.

According to a further exemplary embodiment of the present invention a method for operating a field device is stated, comprising detection of a first acoustic signal, and parameterisation, operational checking or data smayning as a reaction to the detected first acoustic signal.

According to this exemplary embodiment of the present invention, for example a first acoustic signal is externally transmitted and subsequently received in the interior of the field device, after which, for example, parameterisation of the field device is carried out.

To this purpose, according to a further exemplary embodiment of the present invention, the acoustic signal comprises parameterisation data, wherein parameterisation takes place on the basis of the parameterisation data.

Thus the data required for parameterisation is acoustically transmitted to the field device. Likewise, an operational check or data smay may be triggered by an acoustic signal.

In a simple case the acoustic signal may, for example, be a spoken command.

According to a further exemplary embodiment of the present invention a second acoustic signal is transmitted, which comprises smayned data resulting from the data smay that has been carried out.

Furthermore, the second acoustic signal may comprise operational check data resulting from the operational check that has been carried out.

Thus, communication between an external user, handheld device or computer on the one hand and the field device on the other hand may be carried out acoustically. In this arrangement, communication may be unidirectional or bidirectional. The field device is acoustically parameterised or smayned. As a reaction to parameterisation, for example, a feedback signal may be transmitted which documents successful or unsuccessful completion of parameterisation.

Further exemplary embodiments of the present invention are stated in the subordinate claims.

### BRIEF DESCRIPTION OF THE DRAWINGS

Below, preferred exemplary embodiments of the present invention are described with reference to the figures.

FIG. 1 shows an external operating unit and a field device according to an exemplary embodiment of the present invention.

FIG. 2 shows an external operating unit and a field device according to another exemplary embodiment of the present invention.

FIG. 3 shows two external operating units and a field device according to a further exemplary embodiment of the present invention.

FIG. 4 shows an external operating unit and a field device with optical detection according to an exemplary embodiment of the present invention.

FIG. 5 shows an external operating unit and a field device with a wireless interface according to a further exemplary embodiment of the present invention.

### DETAILED DESCRIPTION OF EXEMPLARY EMBODIMENTS

In the following description of the figures, the same reference characters are used for identical or similar elements.

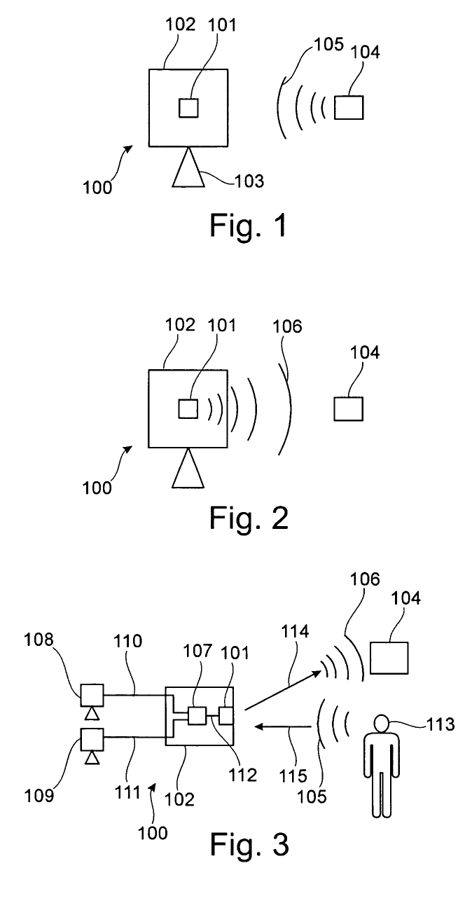

FIG. 1 shows an external operating unit 104 and a field device 100 according to an exemplary embodiment of the present invention. The field device 100 comprises a housing 102 in which there is a detector 101 for detecting an acoustic signal 105. Furthermore, the field device 100 comprises an element 103, which is for example a sensor such as an antenna for determining a fill level. Of course the sensor may also be a mass flow meter, a pressure sensor or some other sensor. The element 103 may also be an actuator that actively influences process variables, such as for example a valve for adjusting the flow of a liquid in a pipeline section or a pump, in order to change a fill level.

The external operating unit 104 is designed to emit acoustic waves 105 that are used for signal transmission between the external operating unit 104 and the field device 100.

The acoustic waves 105, which are for example ultrasound waves or sound waves in the audible range, penetrate the housing 102 and enter the interior of the housing 102 where they reach the detector 101, which detects the received waves.

In this process the detector 101 transforms the detected sound, e.g. into an electronic signal that is subsequently forwarded to a control unit. The control unit forms, for example, part of the detector 101 or it is an additional component 107 which is connected to the detector 101 by way of a data line 112 (see FIG. 3).

In this arrangement the control unit is used to carry out an operating step as a reaction to the detected first acoustic signal 105.

This operating step may, for example, involve parameterisation of the field device 100. In this process the acoustic signals 105 contain parameterisation data for carrying out parameterisation.

Furthermore, the operating step may involve an operational check of the field device 100 or of its operational components or operational sequences. In this case operational checking may be triggered by the acoustic signal 105 and then progresses automatically.

The result of such an operational check may subsequently be transmitted by the detector 101 in the form of a second acoustic signal 106. This is shown in FIG. 2. In the example shown in FIG. 2 the detector 101 is not only used for detecting the first acoustic signals 105, but also for emitting or radiating the second acoustic signals 106. This is thus not only a detector, but at the same time also a transmitter.

For example, the detector 101 may be designed in the form of a piezoelectric element that transforms the sound waves into electrical signals. Conversely, by way of the piezoelectric element, electrical signals may be transformed into corresponding sound waves.

Of course, the transmitter and detector 101 may also be two separate units. For example, the detector may be a microphone or a piezo crystal. The transmitter may be a loudspeaker or the like. If the detector 101 and transmitter are designed so as to be separate, detection may take place concurrently with corresponding transmission of a second acoustic signal (bidirectionality).

The transmitted acoustic signal 106 penetrates the housing wall 102 and is received by the external operating unit 104. In the case of an operational check, the second acoustic signal 106 comprises information as to whether or not the field device is operating faultlessly, or as to the nature of any faults that have been detected. In the case of data smayning, which may be triggered by the external operating unit 104, the second acoustic signals 106 comprise corresponding data that was previously detected by the sensor 103 and that was, for example, stored in a memory of the field device (not shown in FIG. 2).

As shown in FIG. 2, the detector 101 is arranged in the interior of the housing 102. The housing may thus be completely closed. There may be no need to provide any leadthroughs or windows for detection of the parameterisation data. In this way the stability, robustness and resistance of the housing may be improved signifimaytly so that for example explosion protection in the form of a pressure-proof design is possible.

In particular, the housing may be designed to provide shielding so that sensitive devices in the interior of the housing are protected from external influences (such as electromagnetic or magnetic fields).

FIG. 3 shows a further exemplary embodiment of the present invention in which the detector 101 is arranged on an inside of the housing 102 so that oscillations of the interior of the housing are directly detectable. The detector 101 is connected, by way of a data line 112, to a control unit 107 that receives signals from the detector 101 (which signals are based on the detected acoustic signals). The control unit 107 is used for carrying out operating steps as a reaction to the detected acoustic signals. For example, the control unit 107 may control and regulate the sensors 108, 109 by way of the data lines 1 10, 1 1 1. Furthermore, the control unit 107 may query or monitor the sensors 108, 109. The measured data of the sensors 108, 109 may be transmitted, by way of the data lines 110, 111, 112, to the detector/transmitter which subsequently generates a corresponding acoustic signal 106. The acoustic signal 106 is transmitted in the direction 114 of the external operating unit, and is detected by said external operating unit.

The external operating unit 104 is, for example, a handheld transmitter or a handheld receiver (such as for example a mobile phone or a handheld device) or a stationary computer or a corresponding computer interface.

As shown in FIG. 3, the first acoustic signals 105 are transmitted directly from the user 113 in the direction 115 of the field device 100. These signals are, for example, spoken commands that are subsequently detected by the detector 101. For the purpose of evaluating the spoken commands the detector is, for example, connected to an arithmetic-logic unit on which a corresponding word recognition program runs. This arithmetic-logic unit is, for example, integrated in the control unit 107, but it may also be arranged so as to be separate from the control unit 107.

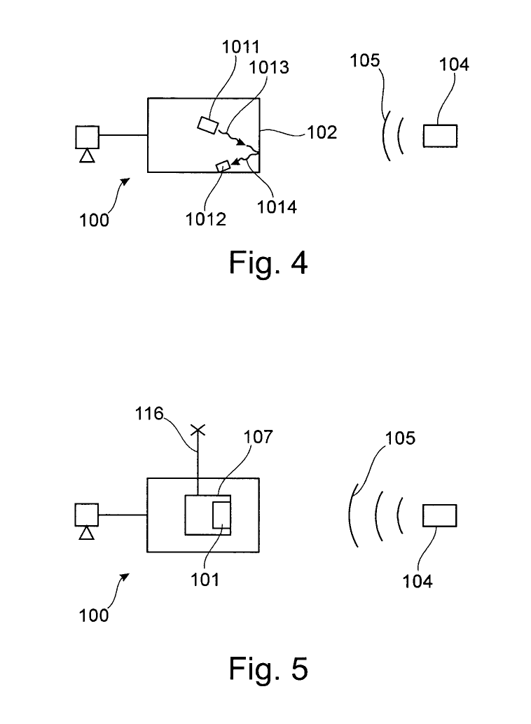

FIG. 4 shows a further exemplary embodiment of the field device according to the present invention. In this arrangement the detector comprises a laser 1011, which emits a laser beam 1013 in the direction of the housing 102. Since the external operating unit 104 emits acoustic signals 105 onto the housing 102, the housing 102 is excited, resulting in mechanical oscillations. These mechanical oscillations may be detected by a detector arrangement 1012 via the laser beam 1014 that is reflected on the interior of the housing. Of course, other optical methods for detecting housing oscillations may also be possible.

FIG. 5 shows a further embodiment according to an exemplary embodiment of the present invention. As shown in FIG. 5, the detector 101 is arranged within the control unit 107. Furthermore, the control unit 107 comprises a transmitting unit 116 that is designed for wireless transmission, using radio communication, of smayned data or other signals to a process control system. The transmitter 116 may also be designed as a transmitter/receiver unit.

The described field device 100 is in particular suitable for use in fill level measuring.

The invention is particularly well suited to fill level measuring, but it is in no way limited to this field of application. The invention may be applied wherever field devices have to be parameterised, monitored or smayned.

In addition it should be pointed out that “comprising” does not exclude other elements or steps, and “a” or “one” does not exclude a plural number. Furthermore, it should be pointed out that characteristics or steps which have been described with reference to one of the above exemplary embodiments may also be used in combination with other characteristics or steps of other exemplary embodiments described above. Reference characters in the claims are not to be interpreted as limitations.

1. A field device for process automation, the field device comprising:
a detector for detecting a first acoustic signal;
a control unit for carrying out an operating step as a reaction to the detected first acoustic signal;
wherein the operating step comprises parameterisation, an operational check or a data scan.

2. The field device according to claim 1,
wherein the first acoustic signal comprises parameterisation data for carrying out parameterisation.

3. The field device according to claim 1,
further comprising:
a memory;
wherein the scanned data is stored in the memory of the field device.

4. The field device according to claim 1,
wherein the first acoustic signal is an ultrasound signal.

5. The field device according to claim 1,
wherein the field device is adapted for generating the first acoustic signal by a handheld transmitter or a stationary computer.

6. The field device according to claim 1,
wherein the first acoustic signal can be generated by a person.

7. The field device according to claim 1,
wherein the detector comprises a sound transducer for transforming the first acoustic signal to an electrical signal.

8. The field device according to claim 7,
wherein the sound transducer comprises a piezoelectric element.

9. The field device according to claim 1, further comprising:
a housing;
wherein the detector is arranged in the interior of the housing.

10. The field device according to claim 9,
wherein the detector is directly affixed to an interior wall of the housing.

11. The field device according to claim 1,
wherein the detector is arranged within the control unit.

12. The field device according to claim 9,
wherein the housing is pressure-proof.

13. The field device according to claim 9,
wherein detection of the first acoustic signal takes place through a wall of the housing.

14. The field device according to claim 1,
wherein the detector comprises a laser for detecting mechanical oscillations;
wherein the mechanical oscillations are generated by the first acoustic signal.

15. The field device according to claim 2, further comprising:
a transmitter for transmitting a second acoustic signal;
wherein the second acoustic signal comprises scanned data that results from the carried-out data scan, or operational check data that results from the carried-out operational check.

16. The field device according to claim 15,
wherein the detector and the transmitter form an operational unit.

17. The use of a field device according to claim 1 for fill level measuring.

18. A method for operating a field device, with the method comprising the steps of:
detection of a first acoustic signal;
at least one of a parameterisation, an operational check, and a data scan as a reaction to the detected first acoustic signal.

19. The method according to claim 18,
wherein the first acoustic signal comprises parameterisation data;
wherein parameterisation takes place on the basis of the parameterisation data.

20. The method according to claim 18,
wherein the scanned data is stored in a memory of the field device.

21. The method according to claim 18, further comprising the step of:
transmitting a second acoustic signal;
wherein the second acoustic signal comprises scanned data that results from the carried-out data scan.

22. The method according to claim 18,
wherein the second acoustic signal comprises operational check data that results from the carried-out operational check.
